(19) United States
(12) Patent Application Publication
(10) Pub. No.: US 2002/0169984 A1
(43) Pub. Date: Nov. 14, 2002

(54) Session management for wireless E-commerce

(76) Inventors: Gopikrishna T. Kumar, Fremont, CA (US); Kannan Avudai, Santa Clara, CA (US); Milind Paltanwale, San Jose, CA (US)

Correspondence Address: HEWLETT-PACKARD COMPANY, Intellectual Property Administration, P.O. Box 272400, Fort Collins, CO, 80527-2400, US

(21) Appl. No.: 09/852,360

(22) Filed: May 9, 2001

(51) Int. Cl. G06F 11/30

(52) U.S. Cl. 713/201

(57) ABSTRACT

Method and apparatus for session management in wireless e-commerce. In various embodiments, the invention manages shopping sessions between wireless communication devices and a merchant application. A gateway module generates respective wireless session identifiers upon receipt of initial requests from the wireless communication devices and provides the wireless session identifiers to the merchant application. The merchant application generates respective merchant session identifiers for the wireless session identifiers and provides the merchant session identifiers to the gateway module. The wireless session identifiers and corresponding merchant session identifiers are associated at the gateway module. In response to subsequent communications from the mobile devices to the merchant application, the gateway module transmits to the merchant application the merchant session identifiers. A user authentication module works in conjunction with the gateway module and authenticates users of the wireless devices.

### FIELD OF THE INVENTION

The present invention generally relates to e-commerce systems, and more particularly to wireless e-commerce systems.

### BACKGROUND

The growth of the Internet has contributed to the growing reliance on e-commerce by retail and business consumers. E-commerce is reshaping both business-to-business and retail transactions. The convenience and efficiency of any particular e-commerce site will play a major role in success or failure of the site.

Access to most present e-commerce sites is made by way of a personal computer (PC) or workstation running web browser software. In accumulating transaction-related information, cookies are often used to pass information between the browser and a vendor's Web server application. For example, a cookie may identify the customer and the items selected for purchase. While the PC-browser combination has certainly served as a useful starting point in the early stages of the adoption of e-commerce, the stationary nature of the PC limits the types of transactions that are suitable for e-commerce. Thus, many vendors are seeking to adapt their e-commerce sites to allow interaction with mobile devices such as wireless telephones and personal digital assistants (PDAs). If more channels are available for access to a vendor's site, it is hoped that more customers will follow.

Unlike present PCs, today's mobile devices have neither the memory capacity nor the processor power to host a browser. While a vendor could wait for mobile devices to become powerful enough to host a browser, waiting could provide competitors with the opportunity to increase market share. Furthermore, even when the power of mobile devices equals the power of present PCs, there will remain many users who will not hurry to move to the new technology mobile devices. Thus, there will be many potential customers who will be beyond the reach of mobile e-commerce vendors. If mobile ecommerce applications are to proliferate, then present e-commerce applications involving web servers must be adapted to accommodate mobile devices having less power than today's PCs.

A system and method that address the aforementioned problems, as well as other related problems, are therefore desirable.

### SUMMARY OF THE INVENTION

In various embodiments, the invention manages shopping sessions between wireless communication devices and an application program such as merchant application. A gateway module generates respective wireless session identifiers upon receipt of initial requests from the wireless communication devices and provides the wireless session identifiers to an application program. The application program generates respective application session identifiers for the wireless session identifiers and provides the application session identifiers to the gateway module. The wireless session identifiers and corresponding application session identifiers are associated at the gateway module. In response to subsequent communications from the mobile devices to the application program, the gateway module transmits the application session identifiers to the application program. A user authentication module works in conjunction with the gateway module and authenticates users of the wireless devices.

It will be appreciated that various other embodiments are set forth in the Detailed Description and claims which follow.

### BRIEF DESCRIPTION OF THE DRAWINGS

Various aspects and advantages of the invention will become apparent upon review of the following detailed description and upon reference to the drawings in which:

FIG. 1 is a functional block diagram of a mobile e-commerce arrangement in accordance with one embodiment of the invention;

FIG. 2 is a flowchart of a process performed by a gateway module in managing session state in mobile e-commerce;

FIG. 3 is a flowchart of a process performed by a merchant application in managing session state in mobile e-commerce; and

FIG. 4 is a flowchart of a process performed by a server wallet module in managing session state in mobile e-commerce.

### DETAILED DESCRIPTION

The various embodiments of the invention are described below in terms of a “merchant application” and a shopping session. It will be appreciated, however, that the invention could be applied to other types of applications that do not involve the purchase of products. Therefore, the embodiments described herein are intended to provide examples to those skilled in the art.

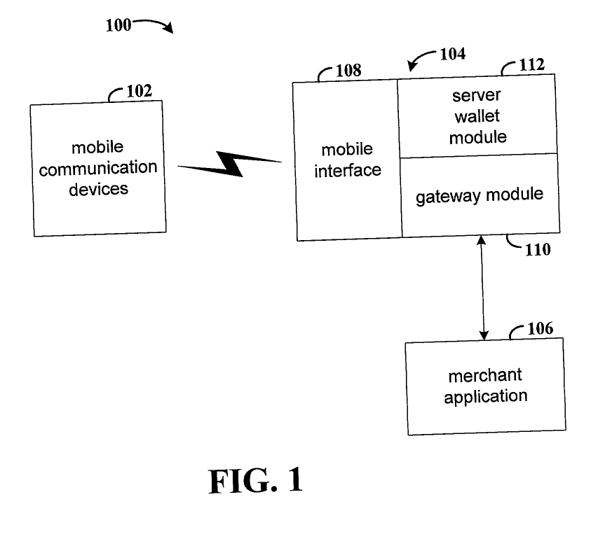

FIG. 1 is a functional block diagram of a mobile e-commerce arrangement in accordance with one embodiment of the invention. Arrangement 100 includes mobile communication devices 102, wireless gateway arrangement 104, and a merchant application 106. Mobile communication devices 102 include, for example, wireless telephones having display screens or PDAs with telecommunication capabilities. It will be appreciated that mobile devices 102 may be possess different degrees of mobility. For example, in one embodiment a PDA has wireless telecommunication capabilities, and in another embodiment a PDA has a telecommunication jack for wired communications.

Merchant application 106 is application software, which is hosted by a suitable data processing system, through which a merchant offers goods or services (hereinafter, “products”) for sale over an electronic communications channel, for example, the Internet. While not shown, it will be appreciated that web server software is used in conjunction with merchant application 106 to coordinate interactions with customers at web browsers.

Wireless gateway arrangement 104 maintains session state between wireless communication devices 102 and merchant application 106 and includes a mobile interface 108, a gateway module 110, and a serverwallet module 112. Interface 108 and applications 110 and 112 can be implemented on one or more data processing systems in accordance with implementation requirements. Mobile interface 108 is implemented with conventional hardware and software conforming to, for example, the Wireless Access Protocol (WAP) standard. Those skilled in the art will appreciate that other alternative protocols could be used substituted to satisfy implementation requirements.

A session is used to identify a set of interactions between a mobile communication device 102 and the merchant application 106. It is necessary to correlate interactions between customers and the merchant application 106 with particular mobile communication devices 102 so that the transactions are consistent with the customers'requests. In one embodiment, a session begins when a mobile device establishes a connection with mobile interface 108 and ends when the connection is closed.

A customer connects with merchant application 106 through the user-interface provided by a mobile communication device 102 and wireless gateway arrangement 104. The mobile interface 108 establishes the initial connection with the mobile communication device 102 and assigns a wireless session identifier (WSID). The WSID is provided to the gateway module 110, and while the connection is maintained, subsequent input requests from the mobile device 102 are associated with the WSID. The gateway module 110 passes WSID to the merchant application 106, which assigns a corresponding merchant session identifier (MSID) and returns the MSID to the gateway module. The gateway module 110 maintains a table that maps the WSIDs to the corresponding MSIDs. After a connection is established between the mobile device 102 and the merchant application 106 and the WSID is mapped to an MSID, the gateway module 110 includes the MSID in subsequent requests from the mobile device to the merchant application.

When a user is ready to complete a transaction, for example, checkout or complete a purchase, the gateway module 110 transfers the WSID and control to the server wallet module 112. The server wallet module creates respective wallet session identifiers (WLSIDs) for sessions seeking to complete a transaction. The first time within a session that a user requests completion of a transaction in an example shopping application, the user is presented with a login screen. Upon successful login from the mobile device, the server wallet module creates a WLSID and associates the WLSID with the WSID of the user in a table. This mapping allows the user to login once to the server wallet module and enable shopping at multiple merchant applications within the same wireless session. After the user has successfully logged in and upon subsequent requests to complete other transactions within the session, the server wallet module presents the user with a choice of payment options and other personal preferences.

A payment request signals the completion of a session between a mobile device 102 and the merchant application 106. The gateway module 110 clears the mapping of the WSID to MSID when a payment request is detected. In order for the mobile device 102 to initiate another transaction with the merchant application 106, the mobile device must reconnect and establish a new WSID with the mobile interface 108, and the merchant application must establish a new MSID.

In one embodiment, a timeout process (not shown) monitors inactivity of the mobile devices 102. After a selected period of inactivity, the connection between a mobile device and the mobile interface 108 is closed, the corresponding WSID-MSID mapping is cleared, the WSID-WLSID mapping is cleared, and the merchant application(s) 106 are notified that the MSID is no longer valid.

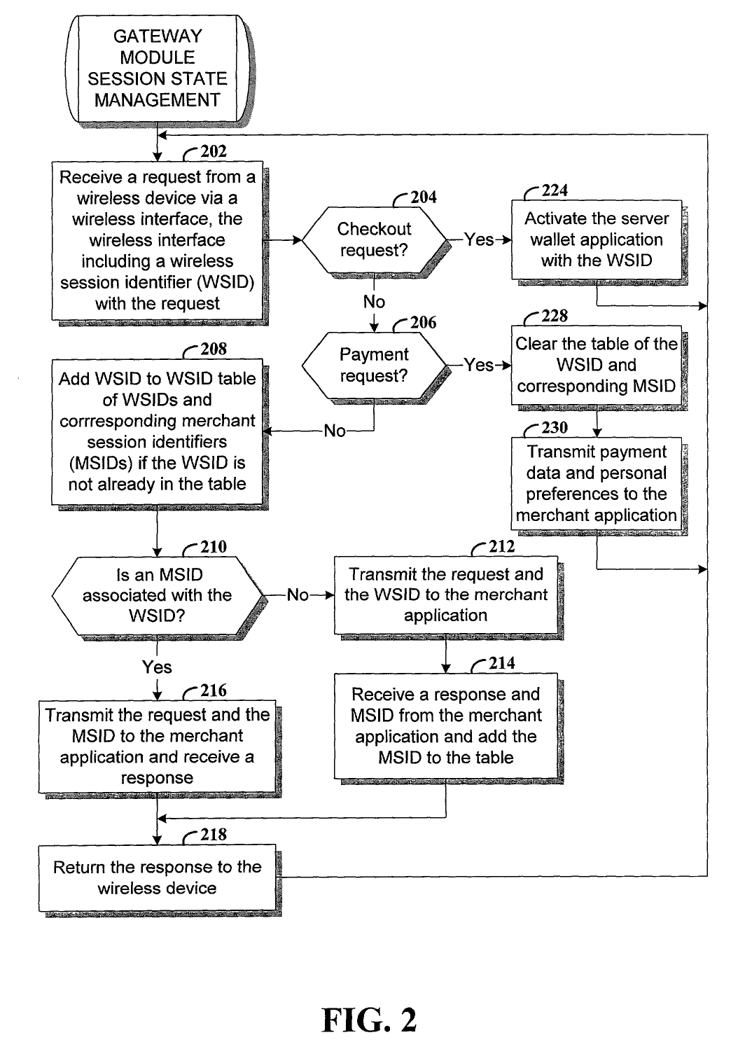

FIG. 2 is a flowchart of a process performed by gateway module 110 in managing session state in mobile e-commerce in accordance with one embodiment of the invention. The process begins at step 202 where the gateway module receives via the mobile interface 108 a request from a mobile communication device. The mobile interface includes with each request the WSID that is associated with the mobile device.

Decision step 204 tests whether the request is a checkout request. In one embodiment, the checkout request indicates that a customer desires to proceed to purchase the product(s). If the request is not a checkout request, the process is directed to decision step 206, to test whether the request is a payment request. The process is directed to step 208 if the request is not a payment request.

At step 208, if there is not already an entry for the WSID in the table that maps the WSIDs to MSIDs, the WSID is added to the table. At decision step 210,if there no MSID associated with the WSID, the process is directed to step 212 where the request and WSID are transmitted to the merchant application. At step 214, the gateway module receives a response from the merchant application that includes a MSID. The MSID is associated with the WSID, and the process proceeds to step 218, When the gateway module receives a request from a mobile device and there is already an associated MSID, decision step 210 directs the process to step 216. At step 216, the request and the MSID that is associated with the WSID are transmitted to the merchant application.

At step 218, the response from the merchant application is provided to the mobile interface 108 for transmission to the mobile device. The process then returns to step 202 to process the next request from the mobile device.

Returning now to decision step 204, when a checkout request is received the process proceeds to step 224. When a checkout request is received, the gateway module activates the server wallet module and provides the WSID from which the checkout request was received. The process then continues at step 202.

When the gateway module receives a payment request from a mobile device, decision step 206 directs the process to step 228. The payment request indicates completion of the transaction, and the WSID and MSID are cleared from the table at step 228. At step 230, data describing payment selections and personal preferences are transmitted to the merchant application for further processing. The process then continues at step 202. If the same mobile device submits further requests to the merchant application, the gateway module will reestablish a WSID-MSID mapping in the table when the merchant application provides a new MSID.

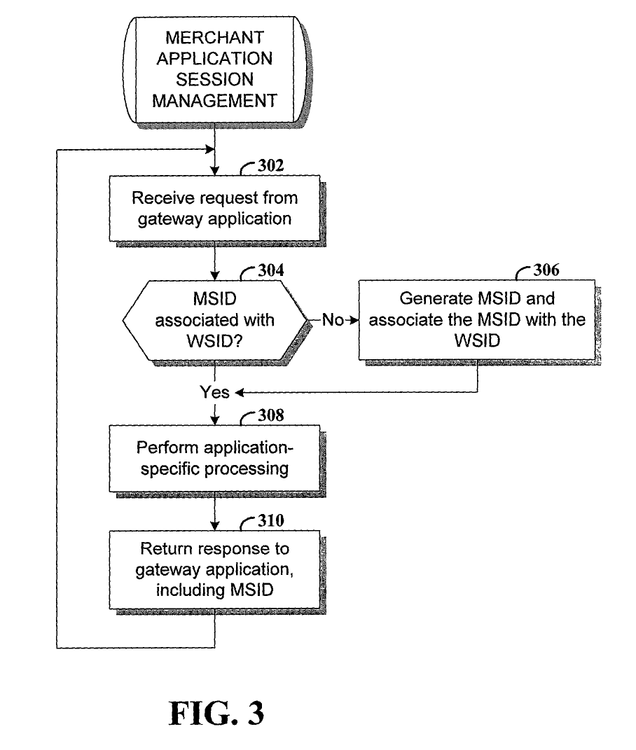

FIG. 3 is a flowchart of a process performed by the merchant application in managing session state in mobile e-commerce in accordance with one embodiment of the invention. At step 302, the merchant application receives a request from the gateway module, and the process continues at decision step 304. The request includes the WSID of the mobile device. Decision step 304 determines whether the merchant application as associated an MSID with the WSID. If not, the process is directed to step 306 where a new MSID is generated and associated with the WSID. The process then continues at step 308.

When an MSID is associated with the WSID in a request, the process is directed to step 308 where the merchant application processes the request in accordance with application-specific logic. At step 310, a response is provided to the gateway module to return to the mobile device. The response includes the MSID that corresponds to the WSID so that the gateway module can provided the MSID in subsequent requests to the merchant application.

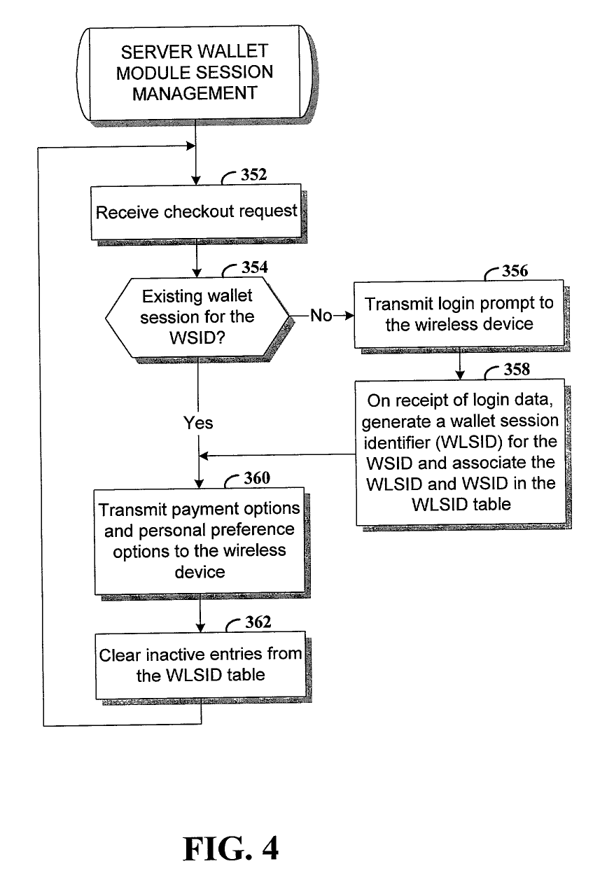

FIG. 4 is a flowchart of a process performed by the server wallet module in managing session state in mobile e-commerce in accordance with one embodiment of the invention. At step 352, the server wallet module receives a checkout request and proceeds to decision step 354. If the mobile device has not yet established a wallet session with the server wallet module, the process is directed to step 356. At step 356, the wallet server application provides a login prompt to the gateway module to transmit to the mobile device. At step 358, on receipt of the login data from the mobile device, a wallet session identifier is generated and associated with the WSID in a WLSID table (not shown). The process then continues at step 360.

Once a wallet session is established with the mobile device, decision step 354 directs the process to step 360 when a checkout request is received. At step 360, the server wallet module provides the gateway module with a prompt to transmit to the mobile device, the prompt containing options for payment options and personal preferences. At step 362, the wallet server application clears inactive entries from the WLSID table. In one embodiment, the wallet server application tracks for each WLSID the most recent time at which a request was received. When there has been a period of inactivity that exceeds a selected threshold for a WLSID, the WLSID is cleared from the table. The process then continues at step 352 as described above.

The present invention is believed to be applicable to a variety of mobile computing applications and has been found to be particularly applicable and beneficial in mobile ecommerce. Other aspects and embodiments of the present invention will be apparent to those skilled in the art from consideration of the specification and practice of the invention disclosed herein. It is intended that the specification and illustrated embodiments be considered as examples only, with a true scope and spirit of the invention being indicated by the following claims.

What is claimed is:

1. A computer-implemented method for managing sessions between mobile communication devices and an application program hosted on a data processing system with a gateway module that is coupled to the mobile communications devices and to the application program, comprising:
generating at the gateway module respective first session identifiers upon receipt of initial requests from the mobile communication devices at the gateway module and transmitting the first session identifiers to the application program;
associating the first session identifiers with corresponding second session identifiers from the application program at the gateway module; and
in response to subsequent communications from the mobile devices to the application program, transmitting from the gateway module to the application program the second session identifiers that are associated with the first session identifiers of the mobile devices of the subsequent communications.

2. The method of claim 1, further comprising:
receiving requests of a first type from the mobile devices at the gateway module and transferring the first type requests to an authentication module that manages user authentication; and
when a user at a mobile device has not logged-in to the authentication module, transmitting a log-in prompt from the authentication module to the mobile device in response to a request of the first type from the mobile device.

3. The method of claim 2, further comprising generating at the authentication module respective authentication identifiers for the first session identifiers and associating the authentication identifiers with corresponding first session identifiers.

4. An apparatus for managing sessions between mobile communication devices and an application program hosted on a data processing system, comprising:
means for generating respective first session identifiers upon receipt of initial requests from the mobile communication devices and transmitting the first session identifiers to the application program;
means for associating the first session identifiers with corresponding second session identifiers from the application program; and
means for transmitting the second session identifiers that are associated with the first session identifiers of the mobile devices to the application program in response to and in association with subsequent communications from the mobile devices directed to the application program.

5. A computer-implemented method for managing shopping sessions between wireless communication devices and a merchant application with a gateway module that is coupled to the mobile communications devices and to the merchant application, comprising:
generating at the gateway module respective wireless session identifiers upon receipt of initial requests from the wireless communication devices at the gateway module and transmitting the wireless session identifiers to the merchant application;
generating at the merchant application respective merchant session identifiers for the wireless session identifiers and transmitting the merchant session identifiers to the gateway module;
associating the wireless session identifiers with corresponding merchant session identifiers at the gateway module; and
in response to subsequent communications from the mobile devices to the merchant application, transmitting from the gateway module to the merchant application the merchant session identifiers that are associated with the wireless session identifiers of the mobile devices of the subsequent communications.

6. The method of claim 5, further comprising:
receiving checkout requests from the wireless communication devices at the gateway module and transferring the checkout requests to a wallet module that manages user authentication;
when a user at a wireless communications device has logged-in to the wallet module, transmitting payment options from the wallet module to the wireless communications device in response to a checkout request from the wireless communications device; and
when a user at a wireless communications device has not logged-in to the wallet module, transmitting a log-in prompt from the wallet module to the wireless communications device in response to a checkout request from the wireless communications device.

7. The method of claim 6, further comprising generating at the wallet module respective wallet session identifiers for the wireless session identifiers and associating the wallet session identifiers with corresponding wireless session identifiers in a wallet session identifier table.

8. The method of claim 7, further comprising, in response to a payment request from a wireless communications device, transmitting the payment request from the gateway module to the merchant application, disassociating the wireless session identifier from the corresponding merchant session identifier, and generating a new wireless session identifier for the wireless communications device when another initial request is received from the wireless communications device.

9. The method of claim 8, further comprising clearing inactive entries from the wallet session identifier table.

10. An apparatus for managing shopping sessions between wireless communication devices and a merchant application, comprising:
means for generating respective wireless session identifiers upon receipt of initial requests from the wireless communication devices and transmitting the wireless session identifiers to the merchant application;
means for associating the wireless session identifiers with corresponding merchant session identifiers received from the merchant application; and
means for transmitting the merchant session identifiers that are associated with the wireless session identifiers of the wireless devices to the merchant application in response to and in association with subsequent communications from the wireless devices directed to the merchant application.

11. A system for managing sessions between mobile communication devices and an application program hosted on a data processing system, comprising:
a mobile interface configured and arranged to connect with a plurality of mobile communication devices;
a gateway coupled to the mobile interface and to the application program, the gateway configured to generate respective first session identifiers upon receipt of initial requests from the mobile communication devices, associate the first session identifiers with corresponding second session identifiers received from the application program, and transmit the second session identifiers that are associated with the first session identifiers to the application program in response to and associated with subsequent communications from the mobile devices to the application program.

12. The system of claim 11, further comprising an authentication module coupled to the mobile interface and to the gateway, the authentication module configured to transmit a log-in prompt to a mobile device in response to a request of the first type from the mobile device.

13. The system of claim 12, wherein the authentication module is further configured to generate respective authentication identifiers for the first session identifiers and associate the authentication identifiers with corresponding first session identifiers.
